(19) United States
(12) Patent Application Publication
(10) Pub. No.: US 2017/0249279 A1
(43) Pub. Date: Aug. 31, 2017

(54) RISER MATRIX

(71) Applicant: HEWLETT PACKARD ENTERPRISE DEVELOPMENT LP, Houston, TX (US)

(72) Inventors: Hung-Chu LEE, Taipei City (TW); Tse-Jen SUNG, Taipei City (TW); Chui Ching CHIU, Taipei City (TW); Kang-Jong PENG, Taipei City (TW); Vincent NGUYEN, Houston, TX (US); Jim KUO, Houston, TX (US)

(73) Assignee: HEWLETT PACKARD ENTERPRISE DEVELOPMENT LP, Houston, TX (US)

(21) Appl. No.: 15/500,088

(22) PCT Filed: Jan. 28, 2015
(86) PCT No.: PCT/US2015/013363

§ 371 Date: Jan. 30, 2017

(51) Int. Cl. G06F 13/42; G06T 1/20; G06F 13/40

(52) U.S. Cl. CPC G06F 13/4282; G06F 13/4068; G06T 1/20; G06F 2213/0026

(57) ABSTRACT

A computing system for dynamically changing at least one input/output configuration between a motherboard of a computing device and at least one node connected to the motherboard includes a plurality of interchangeable topology transformation units (TTU) risers to connect at least one processing device located on a motherboard of the computing system to a plurality of computing nodes. Each of the TTU risers include topologies designed to support different workloads with respect to another TTU riser.

### BACKGROUND

Computing systems are used by a wide array of users, ranging from individual users to large corporations that utilize, for example, computer server devices in day-to-clay operations. Various types of computing systems may be used for a number of types of workloads and may be optimized for a specific type of workload. These workloads include, for example, high performance computing, web server operations, process-intensive computing for industries like financial service industries, graphics processing, and data storage.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1A is a block diagram of an example computing system including a topology transformation unit (TTU) interface and an interchangeable TTU riser.

FIG. 1B is a block diagram of an example computing system including a topology transformation unit (TTU) interface and an interchangeable TTU riser.

FIG. 2 is a block diagram of an example printed circuit board (PCB) of the computing system of FIGS. 1A and 1B depicting a number of potential applications of the interchangeable TTU riser, according to one example of the principles described herein.

FIG. 3 is a block diagram of an example PCB of the computing system of FIGS. 1A and 1B depicting use of a TTU topology associated with the financial services industry.

FIG. 4 is a block diagram of the example PCB of FIG. 3 depicting a number of processing devices coupled to the TTU riser of FIG. 3.

FIG. 5 is a block diagram of the example PCB of the computing system of FIGS. 1A and 1B depicting use of a TTU topology associated with graphics processing unit (GPU) direct peer-to-peer communications.

FIG. 6 is a block diagram of the example PCB of FIG. 5 depicting a number of input/output (I/O) devices and GPU devices coupled to the TTU riser of FIG. 5.

FIG. 7 is a flowchart depicting an example method of changing an input/output (I/O) configuration of the computing system of FIGS. 1A and 1B.

Throughout the drawings, identical reference numbers designate similar, but not necessarily identical, elements.

### DETAILED DESCRIPTION

While a particular computing system may initially satisfy the requirements or a performance level desired by a user, the requirements or desires of that user may change over time. For instance, newer applications of computing systems may be developed that consume more computing resources or consume computing resources in a different manner. Alternatively, in the case of an organization, a system administrator may need to increase the memory capacity and the processing power of a computing system to accommodate additional users or visitors. Most computer server devices support only a few types of workloads. In such cases, a user often must resort to purchasing a new computing platform or server device to satisfy the new requirements or to meet a desired performance metric. Designing different computing platforms targeting a specific workload is expensive and may potentially be sold to a limited market. Thus, design and production of computer server devices targeted at a specific workload may be impermissibly expensive by way of product development, procurement, and sales.

In order to support a wide range of workloads, customers may either deploy different optimized computer server products in their information technology (IT) infrastructures at an extensive monetary cost, or standardize their existing computer systems and cope with sub-optimal performance. Further, to meet customer needs, an original equipment manufacturer (OEM) or original design manufacturer (ODM) must provide a wide range of server products with differing input/output (I/O) configurations and capabilities required for different workloads.

Server computing systems are designed and optimized for one workload. For example, server computing system A, server computing system B, and server computing system C support different workloads. Server computing system A may be, for example, high-performance computing (HPC) system, server computing system B may be a storage server, and server computing system C may be a workstation. Each of these server computing systems is a very expensive product. Having to purchase one of each of these server computing systems in order to achieve a user's current or evolving data processing needs or goals would carry a very large cost burden.

Examples described herein provide a system for dynamically transforming the topology of a computing system. The system includes a first topology transformation unit (TTU) riser to connect a number of processing devices located on a motherboard of the computing system to a plurality of computing devices. A second TTU riser includes a different input/output configuration with respect to the first TTU riser. The first TTU riser is replaceable by the second TTU riser without rendering other elements of the system inoperable.

In one example, the second TTU riser is designed to support a different workload with respect to the first TTU riser. An interface connects the first TTU riser and the second TTU riser to the motherboard, and is located on the motherboard nearest the processing devices. The interface to connect first TTU riser and the second TTU riser to the motherboard is universal with respect to the first TTU riser, the second TTU riser, and a number of additional TTU risers. The first TTU riser and the second TTU riser are made of low-loss material relative to the motherboard to improve signal integrity of the first TTU riser and the second TTU riser. The first TTU riser and the second TTU riser are field replaceable. Each of the TTU risers are coupled directly to the motherboard without intermediary printed circuit board (PCB) layers or interconnect busses.

In order to support different workloads to meet user's current and evolving data processing needs or goals, the multi-node system is able to change and service any workload. The TTU riser described herein provides a hardware solution to achieve these features in a density-optimized multi-node computing system.

As used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

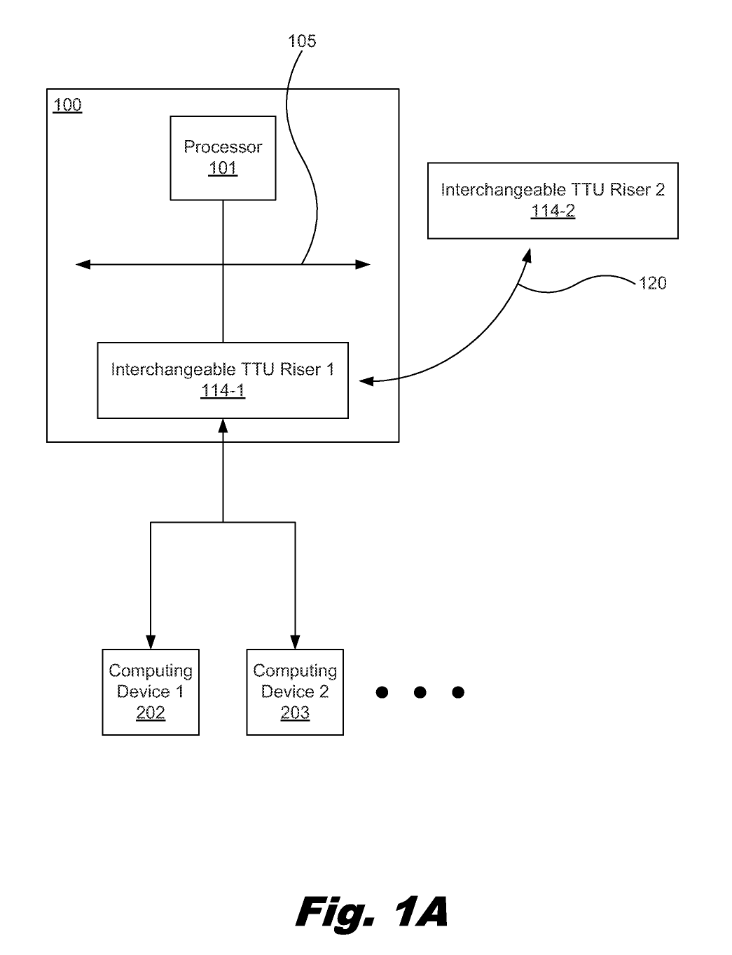

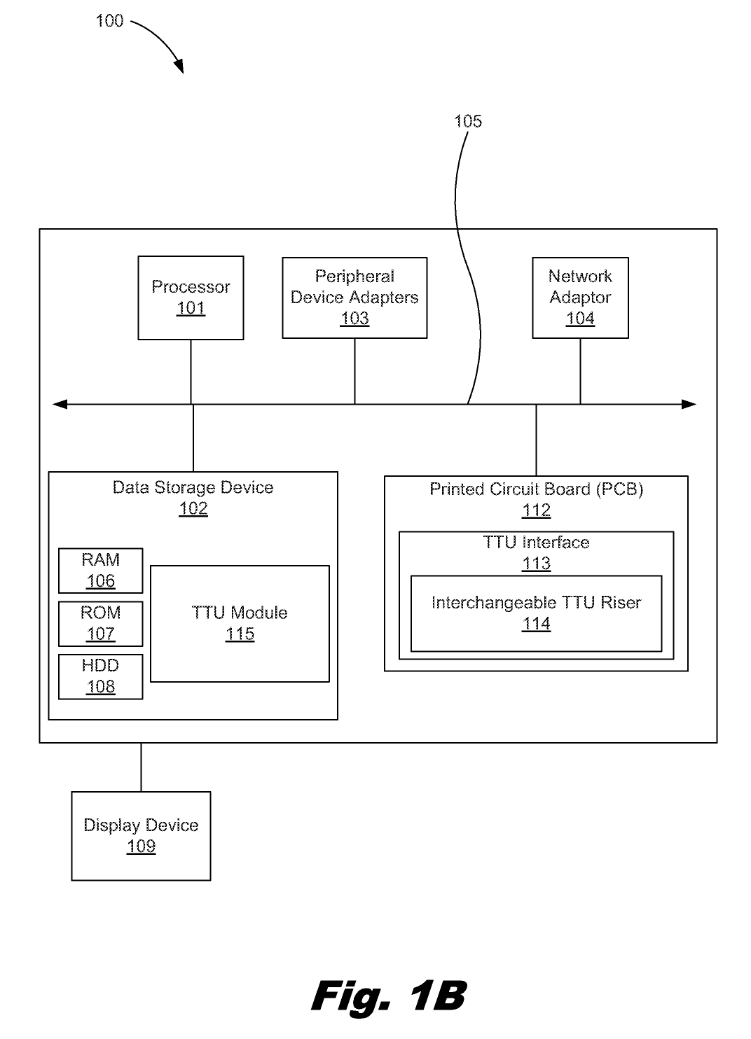

Turning now to the figures, FIG. 1A is a block diagram of an example computing system (100) including at least one interchangeable topology transformation unit (TTU) riser (114-1). Through the use of the plurality of interchangeable TTU risers (114-1), the topology of the computing system (100) may be dynamically transformed to provide computing resources and topologies without rendering other elements of the computing system (100) inoperable. A first interchangeable TTU riser (114-1) connects a number of processing devices such as the processor (101) located on a motherboard of the computing system (100) to a plurality of computing devices (202, 203). An ellipses is depicted in FIG. 1A next to the computing devices (202, 203) to indicate that any number of computing devices may be coupled to the computing system (100). Each computing device (202, 203) represents a different workload that the computing system (100) may be tasked with handling.

A second interchangeable TTU riser (114-2) may replace the first interchangeable TTU riser (114-1) as indicated by arrow 120. The second interchangeable TTU riser (114-2) includes a different input/output configuration with respect to the first interchangeable TTU riser (114-1). In this manner, any number of TTU risers may be employed in the computing system (100) to dynamically transform the topology of the computing system (100) to adjust for the different workloads of the computing device (202 through 208). The interchangeable TTU risers will now be described in more detail in connection with FIG. 1B.

FIG. 1B is a block diagram of an example computing system (100) including a TTU interface (113) and an interchangeable TTU riser (114). The computing system (100) may be implemented as an electronic device. Examples of electronic devices include servers, desktop computers, laptop computers, workstations, personal digital assistants (PDAs), mobile devices, smartphones, gaming systems, and tablets, among other electronic devices.

The computing system (100) may be utilized in any data processing scenario including, stand-alone hardware, mobile applications, through a computing network, or combinations thereof. Further, the computing system (100) may be used in a computing network, a public cloud network, a private cloud network, a hybrid cloud network, other forms of networks, or combinations thereof. In another example, the methods provided by the computing system (100) are executed by a local administrator.

To achieve its desired functionality, the computing system (100) includes various hardware components. Among these hardware components may be a number of processors (101), a number of data storage devices (102), a number of peripheral device adapters (103), a number of network adapters (104), and a number of printed circuit boards (PCBs) (112) including a number of topology transformation unit (TTU) interfaces (113) and a number of interchangeable TTU risers (114). These hardware components may be interconnected through the use of a number of busses and/or network connections. In one example, the processors (101), data storage devices (102), peripheral device adapters (103), network adapters (104), and PCBs (112) may be communicatively coupled via a bus (105).

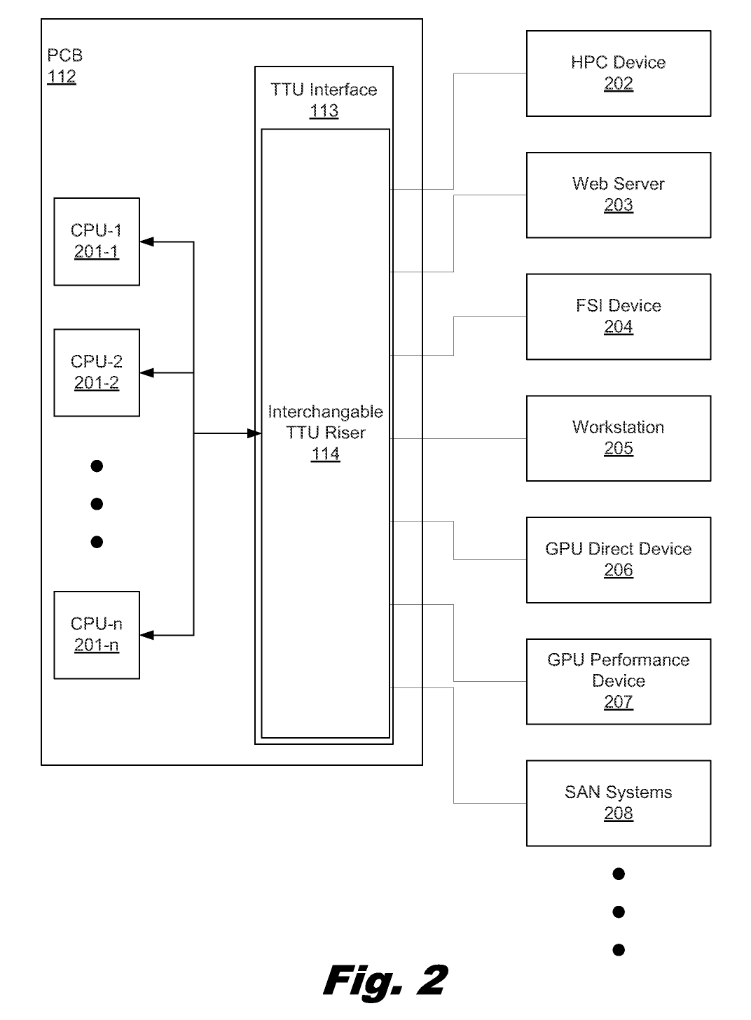

In one example, the TTU riser (114) may include any number of connective interfaces to connect a number of computing devices (FIG. 2, 202 through 208) to the TTU riser (114). In one example, the TTU riser (114) includes between one and three connective interfaces. Each of the computing devices (202 through 208) have disparate workloads, and the different examples of TTU risers (114) described herein include topologies and connective interfaces that provide a best fit for each of these different workloads.

In one example, the TTU risers (114) are made of a low-loss material such as dielectric materials that maintain signal integrity relative to the materials of the PCB (112) or motherboard. As the speed of data signal transfers goes up, it may become difficult to carry a trace lane over high-loss materials in the PCB (112) or a motherboard. In order to reduce the loss to signal integrity experienced in a high-loss materials, the PCB (112) or motherboard may be made of a different dielectric material. However, this becomes expensive as the low-loss materials are more expensive. Therefore, instead of adjusting the materials of the PCB (112) or motherboard, the relatively smaller TTU risers (114) are made of a low-loss material resulting in a less expensive solution to signal integrity degradation. In one example, the size of the TTU riser (114) may be between 1/10^{th} to 1/30^{th} the size of the PCB (112) or motherboard.

The processor (101) may include the hardware architecture to retrieve executable code from the data storage device (102) and execute the executable code The executable code may, when executed by the processor (101), cause the processor (101) to implement at least the functionality of identifying and utilizing a plurality of the interchangeable TTU risers (114) as the plurality of interchangeable TTU risers (114) are coupled to the TTU interface (113), according to the methods of the present specification described herein. In the course of executing code, the processor (101) may receive input from and provide output to a number of the remaining hardware units.

The data storage device (102) may store data such as executable program code that is executed by the processor (101) or other processing device. As will be discussed, the data storage device (102) may specifically store computer code representing a number of applications that the processor (101) executes to implement at least the functionality described herein.

The data storage device (102) may include various types of memory modules, including volatile and nonvolatile memory. For example, the data storage device (102) of the present example includes Random Access Memory (RAM) (106), Read Only Memory (ROM) (107), and Hard Disk Drive (HDD) memory (108). Many other types of memory may also be utilized, and the present specification contemplates the use of many varying type(s) of memory in the data storage device (102) as may suit a particular application of the principles described herein. In certain examples, different types of memory in the data storage device (102) may be used for different data storage needs. For example, in certain examples the processor (101) may boot from Read Only Memory (ROM) (107), maintain nonvolatile storage in the Hard Disk Drive (HDD) memory (108), and execute program code stored in Random Access Memory (RAM) (106).

Generally, the data storage device (102) may include a computer readable medium, a computer readable storage medium, or a non-transitory computer readable medium, among others. For example, the data storage device (102) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The hardware adapters (103, 104) in the computing system (100) enable the processor (101) to interface with various other hardware elements, external and internal to the computing system (100). For example, the peripheral device adapters (103) may provide an interface to input/output devices, such as, for example, display device (109), a mouse, or a keyboard. The peripheral device adapters (103) may also provide access to other external devices such as an external storage device, a number of network devices such as, for example, servers, switches, and routers, client devices, other types of computing devices, and combinations thereof.

The display device (109) may be provided to allow a user of the computing system (100) to interact with and implement the functionality of the computing system (100). The peripheral device adapters (103) may also create an interface between the processor (101) and the display device (109), a printer, or other media output devices. The network adapter (104) may provide an interface to other computing devices within, for example, a network, thereby enabling transmission of data between the computing system (100) and other devices located within the network.

The computing system (100) further includes a number of modules used in the implementation of identifying and utilizing a plurality of the interchangeable TTU risers (114) coupled to the TTU interface (113). The various modules within the computing system (100) include executable program code that may be executed separately. In this example, the various modules may be stored as separate computer program products. In another example, the various modules within the computing system (100) may be combined within a number of computer program products; each computer program product includes a number of the modules.

The computing system (100) may include a topology transformation unit (TTU) module (115) to, when executed by the processor (101), identify and utilize a plurality of the interchangeable TTU risers (114) as the plurality of interchangeable TTU risers (114) are coupled to the TTU interface (113). In one example, the TTU risers (114) are field replaceable units (FRUs). The TTU module (115) identifies an interchangeable TTU riser (114) connected to the TTU interface (113). The TTU module (115) then identifies a number of parameters of the interchangeable TTU riser (114) including a number of busses and the type of busses provided by the interchangeable TTU riser (114). The TTU module (115) performs this identification process each time removal of a TTU riser (114) is detected and when coupling of a subsequent TTU riser (114) to the TTU interface (113) occurs.

As mentioned above, the TTU module (115) identifies a number of parameters of the interchangeable TTU risers (114) including a number of busses and the type of busses provided by the interchangeable TTU risers (114). In one example of a TTU riser (114), two peripheral component interconnect express (PCIe) interfaces may be provided by the TTU riser (114) to provide PCIe connectivity between a number of processing devices and any other computing device.

The TTU riser (114) may provide connectivity to any type of computing device as depicted in FIG. 2. FIG. 2 is a block diagram of an example PCB (112) of the computing system (100) of FIG. 1B depicting a number of potential applications of the interchangeable TTU riser (114). In one example, the PCB (112) is a motherboard of the computing system (100). The TTU riser (114) may couple a number of central processing units (CPUs) (201-1 through 201-n, collectively referred to herein as 201) to a number of computing devices (202 through 208) that provide different computing functions and services. In one example, the CPUs (201) are connected via a QUICKPATH INTERCONNECT (QPI) point-to-point processor interconnect developed by Intel Corporation.

In one example, the TTU riser (114) may couple a number of CPUs (201) to a high-performance computing (HPC) device (202) whose task is to perform trillions of processes per second. In this example, the HPC device (202) receives data from the CPUs (201) in order to, for example, process that data. In this example, the TTU riser (114) includes a number of connections that assist in providing this data to the HPC device (202) in a timely manner.

hi another example, the TTU riser (114) may couple a number of CPUs (201) to a web server (203) that processes requests via hypertext transfer protocol (HTTP). In this example, the web server (203) receives requests for data from the CPUs (201) in order to, for example, present webpage information obtained from the world wide web (WWW). In this example, the TTU riser (114) includes a number of connections that assist in providing web pages to a client computer.

In still another example, the TTU riser (114) may couple a number of CPUs (201) to a financial services industry (FSI) device (204). The finance industry's extreme computing requirements result in a need for a computing system to always be there, provide complete protection for their data, and provide immediate responses to process requests. For example, services provided in the FSI require execution of thousands of buy and sell orders in a matter of seconds. In this scenario, the data will need to execute almost instantaneously in order to avoid loss of billions of dollars that may occur if the transactions do not complete in time. Thus, an FSI device requires a low latency interconnection to meet this immediate response time, and necessitates delivering data through the network stack to the application in the shortest time possible. Thus, through the use of a particular TTU riser (114) specifically made for an FSI application. This particular application of the TTU riser (114) will be described in more detail below.

In yet another example, the TTU riser (14) may couple a number of CPUs (201) to a workstation (205) used to provide technical and scientific computations for personal and business computing. In this example, the workstation (205) may be used in word processing, data processing, and graphics processing scenarios. Thus, in this example, the TTU riser (114) includes a number of connections that assist in providing these personal- and business-level data processing applications.

In yet another example, the TTU riser (114) may couple a number of CPUs (201) to a graphics processing unit (GPU) direct device (206). GPU-direct devices (206) provide peer-to-peer communication for direct communication between GPUs. In this example, if two GPUs and an InfiniBand computer network communications link are connected to a single CPU (201), then the GPUs of the GPU direct device (206) may perform peer-to-peer communication. The InfiniBand device is used in high-performance computing and provides very high throughput and very low latency between a number of GPUs within the GPU direct device (206). Thus, in this example, the TTU riser (114) includes a number of connections that assist in transmission of data between the several GPUs. This particular application of the TTU riser (114) will be described in more detail below.

In yet another example, the TTU riser (114) may couple a number of CPUs (201) to a GPU performance device (207). GPU performance devices (207) may include workstations with low-latency graphics processing capabilities. In this example, the TTU riser (114) includes a number of connections that assist in transmission and display of graphics-related data.

In yet another example, the TTU riser (114) may couple a number of CPUs (201) to a number of storage area network (SAN) systems (208). A SAN system is a dedicated network that provides access to consolidated, block level data storage to enhance storage devices, such as disk arrays that are accessible to servers so that the storage devices appear like locally attached storage devices from the perspective of the operating system of the computing system (100). In this example, the TTU riser (114) includes a number of connections that assist in transmission and storage of data within the SAN system.

In yet another example, the TTU riser (114) may couple a number of CPUs (201) to a number of cloud servers or a network of cloud servers. In this example, the cloud servers may be utilized in any computing scenario including, for example, online gaming. In yet another example, the TTU riser (114) may couple a number of CPUs (201) to a number of computing and storage resources for a server message block (SMB). In yet another example, the TTU riser (114) may couple a number of CPUs (201) to an electronic design automation (EDA) computing environment. In yet another example, the TTU riser (114) may couple a number of CPUs (201) to a number of server appliances or a number if server storage gateway controllers for, for example, a storage area network.

Although several different computing devices (202 through 208) are depicted in FIG. 2, these examples are not exhaustive of the number or types of computing devices that may be coupled to the CPUs (201) via the TTU riser (114) and the TTU interface (113). In one example, the CPUs (201) are connected to the TTU interface (113) and the TTU riser (114) via at least one 40 lane connection. In one example, the several TTU risers (114) may include universal PCB-side connections that allow any TTU riser (114) to couple to the TTU interface (113) located on the PCB (112).

In one example, a number of TTU risers (114) with different topologies and that provide different topological adjustments to the underlying computing system (100) may be sold. In this example, the different TTU risers (114) may be sold as after-market devices that are interchangeable with another TTU riser (114). A user may purchase a TTU riser (114) that provides different topological functionality with respect to a the current functionality of the computing system (100) or the current functionality of an installed TTU riser (114) currently installed in that user's computing system (100) in order to obtain different functionality from his or her computing system (100) that was not available without a TTU riser (114) or without a different TTU riser (114). The TTU risers (114) may be sold separately so that a user can adjust the topology of their computing system (100) as their computing needs change.

In one example, the PCB (112) includes a PLATFORM CONTROLLER HUB (PCH) developed by Intel Corporation to control a number of data paths and support functions used in conjunction with the CPUs (201). These data paths and support functions include clocking, flexible display interlace (FDI), and direct media interface (DMI). In one example, a number of input/output functions may be reassigned between the PCH and the CPUs (201).

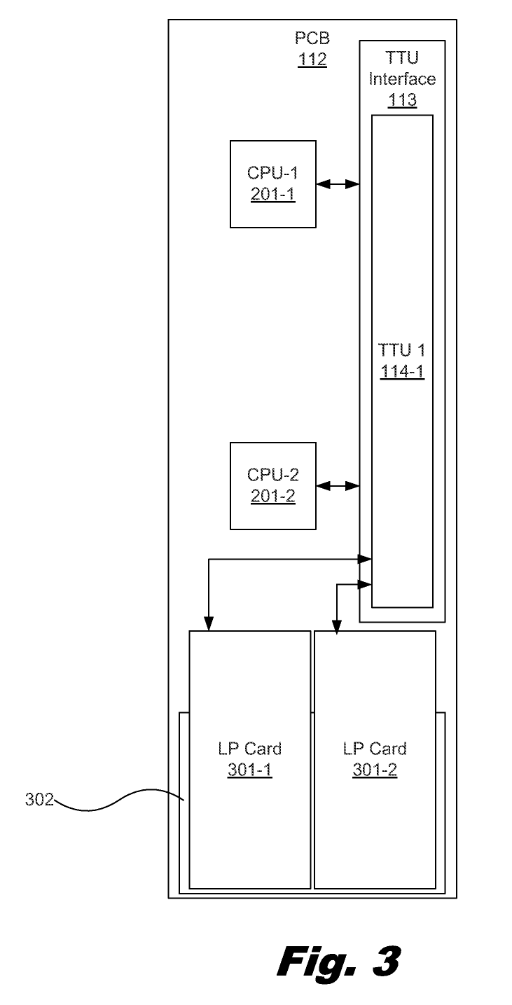

FIG. 3 is a block diagram of an example PCB (112) of the computing system (100) of FIG. 1B depicting use of a TTU topology associated with the financial services industry. As mentioned above, the TTU riser (114-1) may couple a number of CPUs (201) to a financial services industry (FSI) device (204). Services provided in the FSI require execution of thousands of buy and sell orders in a matter of seconds. These services may include purchase and sell of stocks, commodities, derivatives, or other tradeable assets. In this scenario, transactions associated with these tradeable assets will need to execute almost instantaneously in order to avoid loss of billions of dollars that may occur if the transactions do not complete in time. Thus, an FSI device requires a low latency interconnection to meet this immediate response time, and necessitates delivering data through the network stack to the application in the shortest time possible.

Thus, through the use of a particular TTU riser (114-1) specifically made for an FSI application, data processing goals associated with financial services are achieved. This is achieved by assigning each of the CPUs (201-1, 201-2) to a respective one of the PCIe risers (301-1, 301-2) of the TTU riser (114-1). In this manner, the workloads experienced in the financial services industry may be divided between the two CPUs (201-1, 201-2) and a respective one of the PCIe risers (301-1, 301-2).

In one example, a user may choose a TTU riser (114-1) for coupling to the TTU interface (113) that provides functionality associated with the goals associated with the financial services industry. In one example, the user may choose a PCIe x16 low profile riser (301-1) and PCIe x16 long riser (301-2) to build dual network interface controller (NIC) cards in the computing system (100). Each riser (301-1, 301-2) is electrically coupled to the CPUs (201-1, 201-2), respectively. An I/O device (302) is also provided to input and output data to and from the PCB (112). In one example, the I/O device (302) may include a number of PCIe connectors. In this example, the I/O device (302) is an I350 series local area network (LAN) controller including a dual-port or quad-port and a 1 Gbit/s, PCIe 2.1 connection.

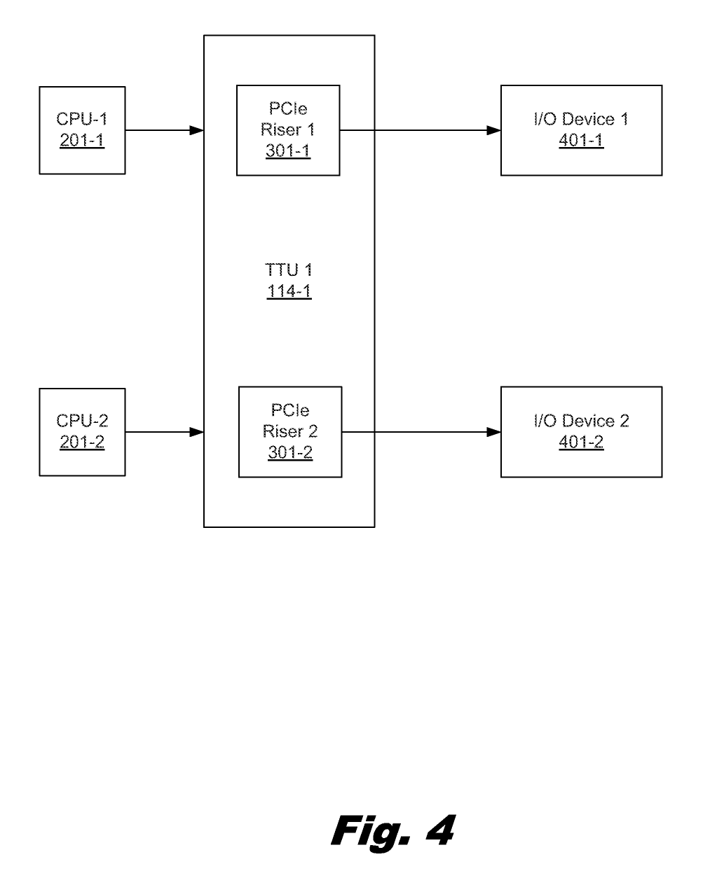

FIG. 4 is a block diagram of the example PCB (112) of FIG. 3 depicting a number of processing devices coupled to the TTU riser (114) of FIG. 3. In this example, the TTU riser (114-1) provides the PCIe risers (301-1, 301-2) in order to couple the computing system to the I/O devices 1 and 2 (401-1, 401-2). Thus, in this FSI application, the TTU riser (114-1) acts as a PCIe bus to distribute and balance workloads associated with the FSI processes executed by the computing system (100).

In one example, the PCIe x16 low profile riser (301-1) and PCIe x16 long riser (301-2) may each have a width within a computing resource bay equal to half the width of the computing resource bay. Further, the height of each of the PCIe x16 low profile riser (301-1) and PCIe x16 long riser (301-2) may be one unit (1U). Thus, because it is very difficult to physically fit the two low-profile cards (301-1, 301-2) into one half-width node space, the TTU riser (114-1) provides for connectivity to the I/O devices (401-1, 401-2) in a physically smaller space. In this manner, a single 2U4N computing system may support up to four nodes, with each node providing eight low profile option cards (301-1, 301-2). Thus, in a dense data center environment, the examples described herein provide a more dense computing system that is fit for financial service applications.

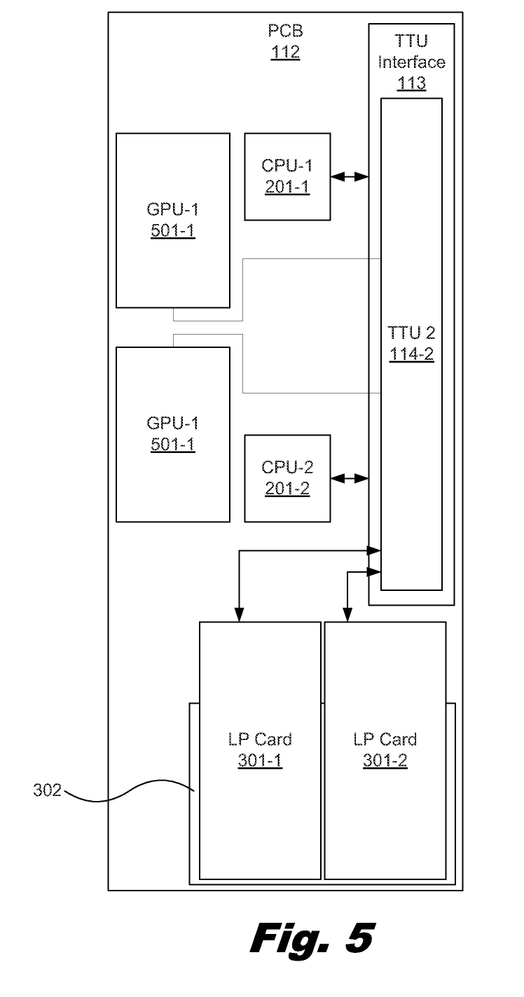

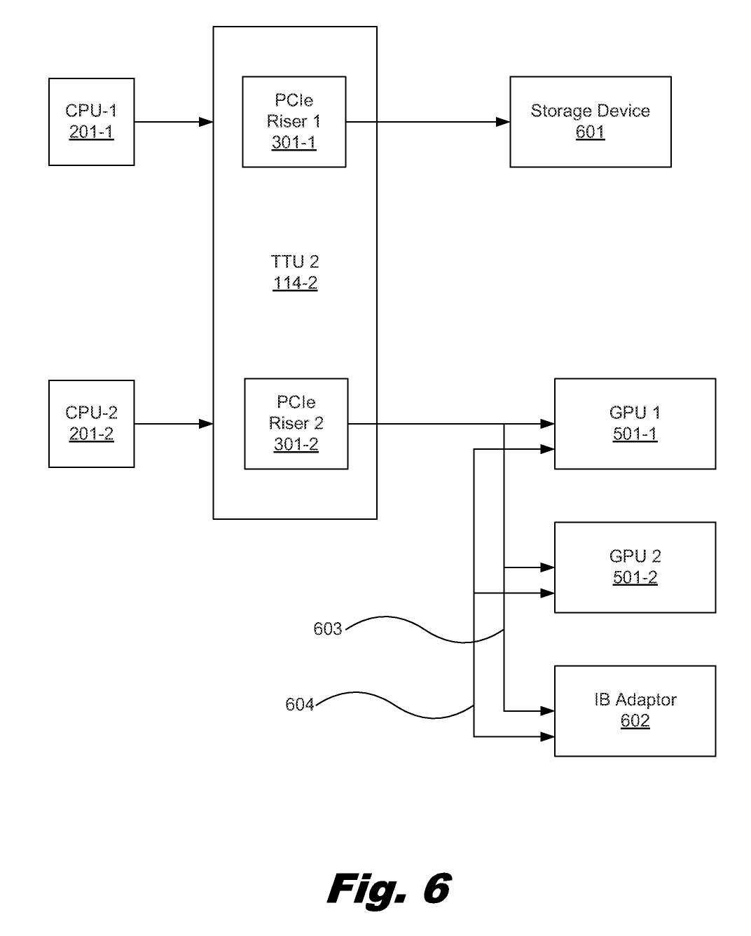

FIG. 5 is a block diagram of the example PCB (112) of the computing system of FIG. 1B depicting use of a TTU topology associated with graphics processing unit (GPU) direct peer-to-peer communications. FIG. 6 is a block diagram of the example PCB (112) of FIG. 5 depicting a number of input/output (I/O) devices and GPU devices coupled to the TTU riser (114-2) of FIG. 5. As mentioned above, GPU-direct devices (206) provide peer-to-peer communication for direct communication between GPUs (501-1, 501-2). As depicted in FIG. 6, two GPUs (501-1, 501-2) and an InfiniBand computer network communications link device (602) are connected to a CPU (201) via the TTU riser (114-2).

The GPUs (501-1, 501-2) of the GPU direct device (FIG. 2, 206) may perform peer-to-peer communication using the direct connection (604) with communication with the CPUs (201) being provided through bus (603). The InfiniBand device (602) is used in high-performance computing and provides very high throughput and very low latency between the GPUs within the GPU direct device (206). Thus, in this example, the TTU riser (114-2) includes a number of connections that assist in transmission of data between the several GPUs (501-1, 501-2) and between the GPUs (501-1, 501-2) and the CPUs (201). In one example, the GPUs (501-1, 501-2) communicate with one of the two CPUs (201-1) rather than both. This is done in order to allow the CPU (201) not communicating with the GPUs (501-1, 501-2) to provide processing resources for another workload such as the storage device (601).

In the example of FIGS. 5 and 6, data may be transmitted from one GPU (501-1, 501-2) over the PCIe bus created by the TTU riser (114-2) directly to another GPU (501-1, 501-2). Transmitting data via this path provides for less latency and higher bandwidth. The example of FIGS. 5 and 6 eliminates unnecessary system memory copies and reduces the utilization of multi-node system CPUs (201) and latency that may otherwise occur without the TTU riser (114-2).

In one example, the topology of the GPU direct application depicted in FIGS. 5 and 6 may provide a 2U PCIe long riser (301-2) to fan out all PCIe busses from the same CPU (210-1, 201-2) in the limited 2U half-width space. This solution provides a user with the ability to achieve GPU direct peer-to-peer communications in one 2U half-width node space. The GPU direct device (FIG. 2, 206) may include a 2U x16×16×16 long riser (301-2) to connect the two GPUs (501-1, 501-2) and an InfiniBand device (602) to achieve peer-to-peer transfers between the GPUs (501-1, 501-2) on the same PCIe bus. One 2U4N computing system (100), for example, may support two computing nodes and each computing node may provide the two GPUs (501-1, 501-2) and one InfiniBand device (602). The example of FIGS. 5 and 6 also includes a storage device (601). The storage device (601) may be coupled to the TTU riser (114-2) via a 1U x16 low profile PCIe riser (301-1). The storage device (601) Thus, the example of FIGS. 5 and 6 provides a more dense but more flexible and capable computing system (100).

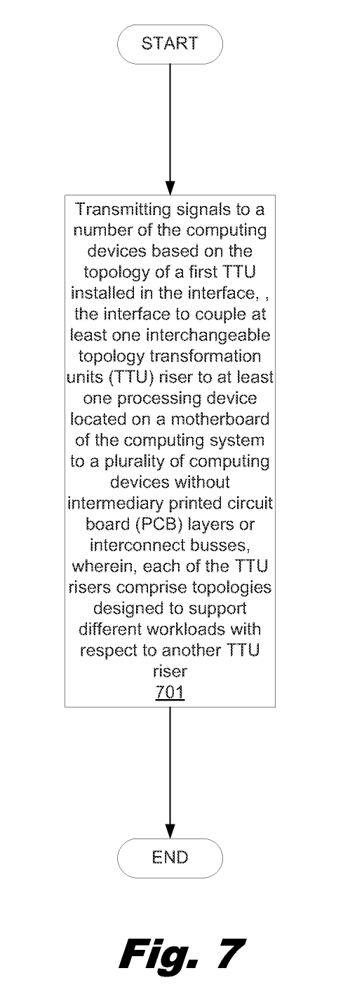

FIG. 7 is a flowchart depicting an example method of changing an input/output (I/O) configuration of the computing system of FIG. 1B. The method may include transmitting (block 701) signals to a number of the computing devices (202 through 208) based on a topology of a first TTU riser (114) installed in the interface (113). The interface (113) couples a number of interchangeable topology transformation unit (TTU) risers (114) to a number of processing devices (201) located on a motherboard (112) of the computing system (100) to a plurality of computing devices (202 through 208) without intermediary printed circuit board (PCB) layers or interconnect busses. In one example, each of the TTU risers (114) includes topologies designed to support different workloads with respect to another TTU riser (114). In one example, the TTU interface (113) is universal with respect to each of the TTU risers (114).

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (101) of the computer system (100) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a computing system for dynamically changing a number of input/output configurations between a motherboard of a computing device and a number of nodes connected to the motherboard includes a plurality of interchangeable topology transformation units (TTU) risers to connect a number of processing devices located on a motherboard of the computing system to a plurality of computing nodes. Each of the TTU risers include topologies designed to support different workloads with respect to another TTU riser. This computing system may have a number of advantages, including: (1) a savings in the cost of silicon by not having to create more space on a PCB as a motherboard; (2) a reduction in design cost significantly without using a different motherboard PCB of a server computing system; (3) providing, via the TTU riser, a number of PCIe buses from different processors in a limited space; (4) providing alternative routing channels to alleviate PCB or motherboard layout congestion; (5) with the use of low-loss PCB material at the TTU riser rather than on PCB or motherboard to overcome signal integrity issues for system complex topologies resulting in a significant manufacturing cost savings; (6) providing the ability to use different TTU risers to build a computing system that meets a user's computing performance needs in a dynamic manner as those needs change; (7) providing a pure hardware solution to achieve the features described herein in a density-optimized multi-node system.

The preceding description has been presented to illustrate and describe examples of the principles described. This description is not intended to be exhaustive or to limit these principles to any precise form disclosed. Many modifications and variations are possible in light of the above teaching.

What is claimed is:

1. A system for dynamically transforming the topology of a computing system comprising:
a first topology transformation unit (TTU) riser to connect at least one processing device located on a motherboard of the computing system to a plurality of computing devices; and
wherein the first TTU riser is replaceable by a second TTU riser without rendering other elements of the system inoperable.

2. The system of claim 1, wherein the second TTU riser is designed to support a different workload with respect to the first TTU riser.

3. The system of claim 1, wherein an interface to connect the first TTU riser and the second TTU riser to the motherboard is located on the motherboard nearest to the processing devices.

4. The system of claim 1, wherein an interface to connect the first TTU riser and the second TTU riser to the motherboard is universal with respect to the first TTU riser, the second TTU riser, and at least one additional TTU riser.

5. The system of claim 1, wherein the first TTU riser and the second TTU riser are made of low-loss material relative to the motherboard to improve signal integrity of the first TTU riser and the second TTU riser.

6. The system of claim 1, wherein the first TTU riser and the second TTU riser are field replaceable.

7. The system of claim 1, wherein each of the TTU risers are coupled directly to the motherboard without intermediary printed circuit board (PCB) layers or interconnect busses.

8. A computing system for dynamically changing at least one input/output configuration between a motherboard of a computing device and at least one node connected to the motherboard, comprising:
at least one interchangeable topology transformation unit (TTU) riser to connect at least one processing device located on a motherboard of the computing system to a plurality of computing nodes:
wherein, the at least one TTU riser comprises a topology designed to support at least one workload that is different with respect to a second TTU riser.

9. The computing system of claim 8, wherein the TTU riser is replaceable by the second TTU riser without rendering other elements of the computing system inoperable.

10. The computing system of claim 8, wherein the TTU riser comprises a different input/output configuration with respect to the second TTU riser.

11. The computing system of claim 8, wherein the TTU riser is sold as an after-market computing device.

12. The computing system of claim 8, wherein the TTU riser provides at least one peripheral component interconnect express (PCIe) connection from the at least one processing device located on the motherboard with the at least one computing node.

13. The computing system of claim 8, wherein the TTU riser is coupled directly to the motherboard without intermediary printed circuit board (PCB) layers or interconnect busses.

14. A method of changing an input/output configuration of a computing system comprising:
transmitting signals to the at least one computing device based on a topology of a first TTU riser installed in an interface, the interface to couple at least one interchangeable topology transformation units (TTU) riser to at least one processing device located on a motherboard of the computing system to a plurality of computing devices without intermediary printed circuit board (PCB) layers or interconnect busses;
wherein, each of the TTU risers comprise topologies designed to support different workloads with respect to another TTU riser.

15. The method of claim 14, wherein the interface is universal with respect to each of the TTU risers.
